(19) United States
(12) Patent Application Publication
(10) Pub. No.: US 2016/0236338 A1
(43) Pub. Date: Aug. 18, 2016

(54) REVERSING CONTROL MECHANISM OF PNEUMATIC TOOLS

(71) Applicant: Ching-Shun CHANG, Taichung City (TW)

(72) Inventor: Ching-Shun CHANG, Taichung City (TW)

(73) Assignees: Wei-Ting CHANG, Taichung City (TW); Yu-Chin CHEN, Taichung City (TW)

(21) Appl. No.: 15/001,748

(22) Filed: Jan. 20, 2016

(30) Foreign Application Priority Data
Feb. 13, 2015 (CN) 201510078298.2

(51) Int. Cl. B25F 5/00; B25B 21/00

(52) U.S. Cl. CPC B25F 5/001; B25B 21/00

(57) ABSTRACT

A reversing control mechanism of a pneumatic tool includes a rear cover, a reducing through-hole, a diversion seat, a flow switch control seat, a knob portion and a reducing through-hole at rear end of the rear cover trough. The reversing control mechanism is only composed of the rear cover, diversion seat and flow switch control seat, enabling the knob portion to be formed directly onto the rear end of the flow switch control seat. The rear cover, diversion seat and flow switch control seat are coaxially sleeved and located for strong reliability. The knob portion is exposed to the reducing through-hole at rear end of the trough of the rear cover, making convenient operation possible.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a pneumatic tool, and more particularly to an innovative one which is designed with a reversing control mechanism.

2. Description of Related Art Including Information Disclosed Under 37 CFR 1.97 and 37 CFR 1.98

The structural design of a pneumatic tool involves three major parts: vane rotor, cylinder and reversing mechanism; of which the reversing mechanisms is used to switch the air inlet/exhaust path/direction of the pneumatic tool, thus changing the rotation of the vane rotor and steering shaft for loosening or locking purpose; the present invention is intended to make some breakthrough progress on the reversing mechanism of the pneumatic tool.

The reversing mechanism of the existing pneumatic tool is mainly structured in a way that a pneumatic tube is mounted below the pneumatic portion of the pneumatic tool, where a forward/reverse through-hole connected to the air chamber is arranged; besides, the pneumatic tube is connected to the pneumatic source tube; then a movable reversing rod is set into the pneumatic tube, so as to control the reversing action of the air path; yet, the main body of the pneumatic tool is increased with respect to its overall height since a pneumatic tube is mounted below the pneumatic portion of the pneumatic tool; hence, the holding portion will be lowered to deviate from the center of gravity of the pneumatic tool, making it hard to align with the objects due to the shaking of the pneumatic portion.

In view of the aforementioned problems, another typical structure that allows to mount the reversing mechanism to the near-rear end of the pneumatic portion has been invented, with a reference to ROC patent No. 573594 “a reversing mechanism of pneumatic tool”, wherein a forward/reversing valve is formed into the rear seat of the pneumatic tool with a trough, such that it is capable of switching the direction of air inlet/exhaust; a valve rod hole connected externally is set on the rear seat; besides, another forward/reversing valve rod is arranged near the rear side within the rear seat ; the forward/reversing valve rod is provided with a connecting hole for sleeving onto the protruding rod formed on the center of the forward/reversing valve, enabling the action of the forward/reversing valve with the toggling of the forward/reversing valve rod; notwithstanding such typical pneumatic tool's reversing mechanism has improved the previous structure, it is still found that no breakthrough improvement has been made, for example, the independent fabrication of the forward/reversing valve rod and then assembly with the forward/reversing valve will result in difficulty in assembly, higher fabrication cost and negative impact on the stability of the overall structure

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

Based on the innovative structure and technical characteristics of the present invention wherein the “reversing control mechanism of pneumatic tool” mainly comprises: rear cover, reducing through-hole, diversion seat, flow switch control seat, knob portion and reducing through-hole at rear end of the rear cover trough, said reversing control mechanism is only composed of the rear cover, diversion seat and flow switch control seat, enabling the knob portion to be formed directly onto the rear end of the flow switch control seat; besides, the rear cover, diversion seat and flow switch control seat are coaxially sleeved and located for strong reliability; moreover, the knob portion is exposed to the reducing through-hole at rear end of the trough of the rear cover, making it possible for convenient operation; thus the pneumatic tool's reversing control of the present invention has advantages such as simple construction, robust structure and ease of operation, etc.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is an exploded perspective view of the preferred embodiment of the present invention.

FIG. 2 is another exploded perspective view of the reversing control mechanism of the present invention.

FIG. 3 is an exploded sectional view of the reversing control mechanism of the present invention.

FIG. 4 is a combined sectional view of the reversing control mechanism of the present invention.

FIG. 5 is another combined view of the reversing control mechanism of the present invention when the flow switch control seat is rotated to different angles.

FIG. 6 is a plane view of the present invention when the knob portion of the flow switch control seat is rotated to preset air closing mode.

FIG. 7 is a view of FIG. 6 showing the channel state of the diversion seat and the flow switch control seat.

FIG. 8 is a plane view of the present invention wherein the knob portion of the flow switch control seat is rotated to first preset air inlet mode.

FIG. 9 is a view of FIG. 8 showing the channel state of the diversion seat and the flow switch control seat.

FIG. 10 is a sectional view of 9 showing the diversion seat exhaust channel.

FIG. 11 is an air inlet path perspective view of the first preset air inlet mode of the present invention.

FIG. 12 is an air exhaust path perspective view of the first preset air inlet mode of the present invention.

FIG. 13 is a plane view of the present invention wherein the knob portion of the flow switch control seat is rotated to second preset air inlet mode.

FIG. 14 is a view of FIG. 13 showing the channel state of the diversion seat and the flow switch control seat.

### DETAILED DESCRIPTION OF THE INVENTION

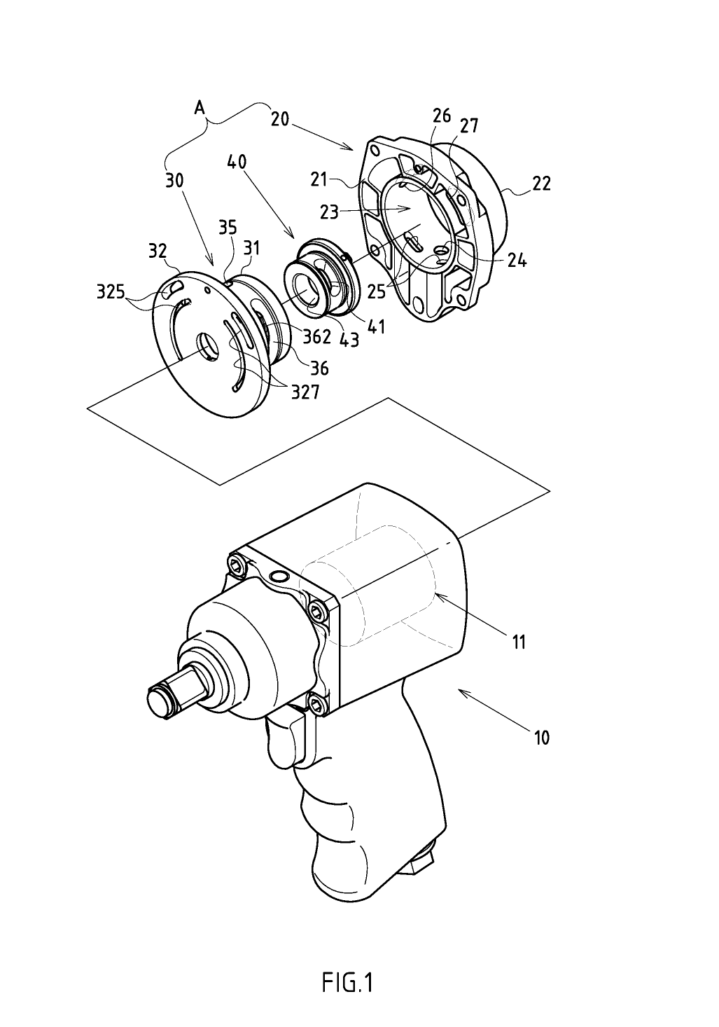

FIGS. 1-7 depict preferred embodiments of a pneumatic tool's reversing control mechanism of the present invention, which, however, are provided for only explanatory objective for patent claims. Said reversing control mechanism A is assembled correspondingly to the rear end of the pneumatic portion 11 of the pneumatic tool 10, enabling to the switch the opening/closing of air pressure path and air inlet/exhaust mode of the pneumatic tool 10. The reversing control mechanism A comprises:
a rear cover 20, comprising an assembly end 21 and a rear side 22; said assembly end 21 is assembled at the rear end of the pneumatic portion 11 of the pneumatic tool 10; said rear cover 20 is also provided with a trough 23, at bottom of which an air inlet hole 24 and two exhaust holes 25 are extended to the assembly end 21; a first exhaust channel 26 and a second exhaust channel 27 are arranged at left and right sides at top of the trough 23;
a reducing through-hole 28, set at the rear end of the trough 23 of the rear cover 20 for passing through the rear side 22 of the rear cover 20;
a diversion seat 30, comprising a cylinder 31 and an expanding disc 32 set at front end of the cylinder 31; of which said cylinder 31 is located into the trough 23 of the rear cover 20, and the expanding disc 32 is abutted onto the assembly end 21 of the rear cover 20; said cylinder 31 is divided into a front section 312 and a rear section 314; exhaust channels 33 are set at bottom of the front section 312, and a punching hole 34 is set at bottom of the rear section 314; a first elongated punching channel 35 and a second elongated punching channel 36 are separately arranged on the exterior side of the rear section 314 of the cylinder 31; moreover, exhaust holes 352, 362 are separately set at upper part of the first and second elongated punching channels 35, 36, and separately linked to the inner upper part of the cylinder 31; inlet holes 354, 364 are separately set at lower part of the first and second elongated punching channels 35, 36, and separately linked to the inner lower part of the cylinder 31; besides, a first air diversion channel 325 and a second air diversion channel 327 are set symmetrically at two sides of the expanding disc 32;
a flow switch control seat 40, which is rotarily assembled into the rear section 314 of the cylinder 31 of the diversion seat 30; an exhaust switch groove 41 and an inlet switch groove 42 are separately set at upper and lower sides of the flow switch control seat 40; an axial notch 43 recessed backwards is set at front end of the flow switch control seat 40; said axial notch 43 is only connected with the exhaust switch groove 41, and separated from the inlet switch groove 42;
of which, a knob portion 44 is formed at the rear end of the flow switch control seat 40, and located correspondingly to the reducing through-hole 28 at the rear end of the trough 23 on the rear cover 20, enabling the knob portion 44 to be exposed for convenient control (note: the knob portion 44 can be manually operated through the reducing through-hole 28).

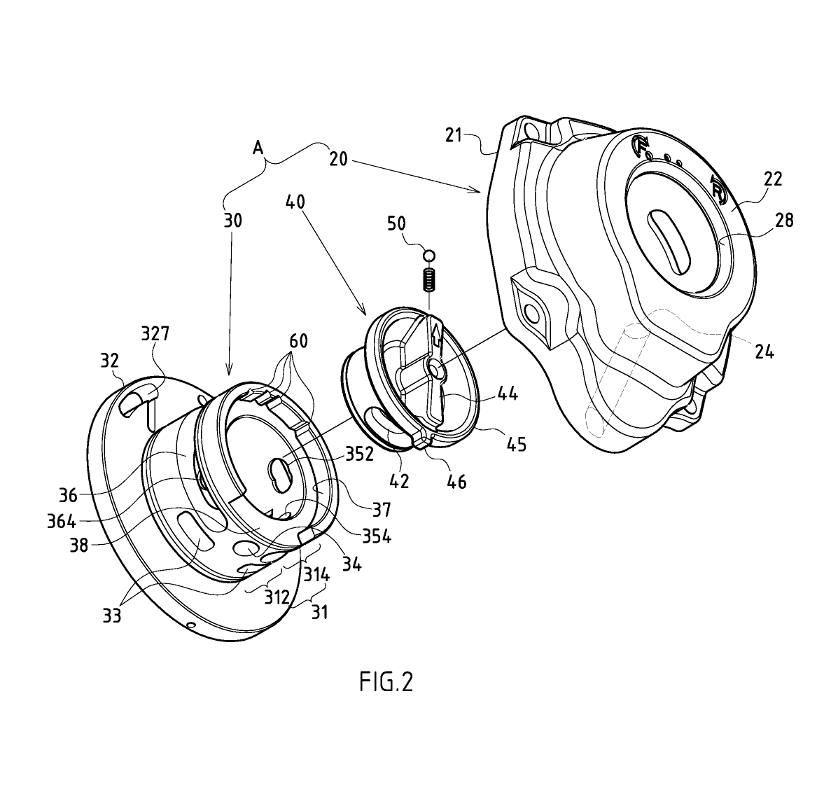

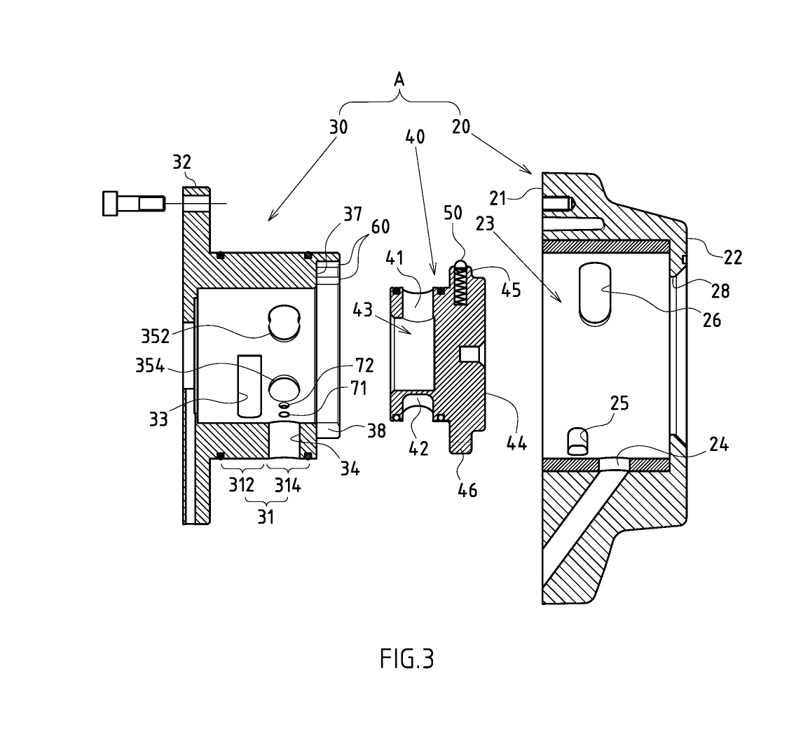

Referring to FIGS. 2, 3, an expanding limit groove 37 is also set at the rear end of the cylinder 31 of the diversion seat 30. A limiting notch 38 is set at one side of the expanding limit groove 37. An expanding ring 45 is set at rear end of the flow switch control seat 40, and can be accommodated into the expanding limit groove 37. Moreover, a bulge 46 set at one side of the expanding ring 45 is located into the limiting notch 38, such that the maximum rotating angle of the flow switch control seat 40 can be implemented as the displacement of the bulge 46 is limited by the limiting notch 38.

Referring to FIGS. 2, 3, an elastic bead 50 is set on the expanding ring 45 at the rear end of the flow switch control seat 40, while a plurality of locking flanges 60 are spaced at one side of the expanding limit groove 37 at the rear end of the cylinder 31 of the diversion seat 30, such that the rotation state of the flow switch control seat 40 could be located sectionally, allowing to identify the opening/closing of air pressure path and air inlet/exhaust mode of the pneumatic tool 10.

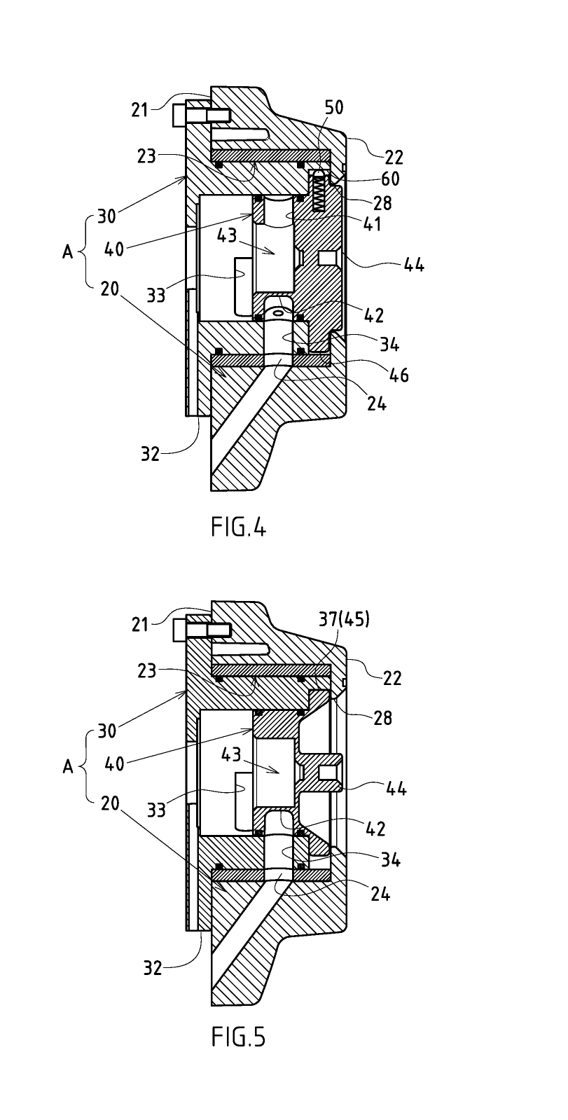

Of which, the knob portion 44 formed at rear end of the flow switch control seat 40 can be protruded out of the reducing through-hole 28 (shown in FIGS. 4, 5), or located within the reducing through-hole 28.

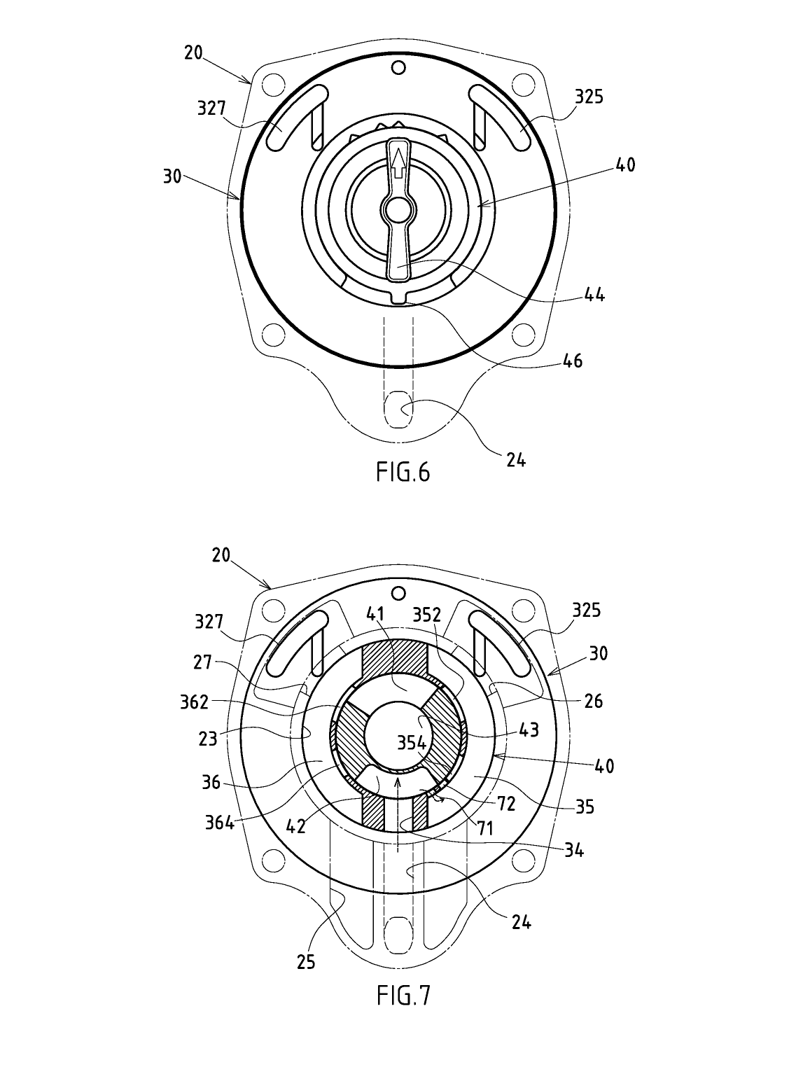

Referring to FIG. 3, a plurality of sectional inlet adjusting holes 71, 72 are arranged between the inlet hole 354 at lower end of first elongated punching channel 35 of the diversion seat 30 and the punching hole 34 of the diversion seat 30. The aperture of said sectional inlet adjusting holes 71, 72 is smaller than that of the inlet hole 354. Referring to FIG. 6, when the knob portion 44 is rotated to the first inlet mode and located at the first preset section, the channel alignment state of the diversion seat 30 and flow switch control seat 40 is illustrated in FIG. 7. In such a case, the inlet switch groove 42 of the flow switch control seat 40 is aligned simultaneously with the punching hole 34 of the diversion seat 30 and either of said sectional inlet adjusting holes 71. Hence, air pressure guided from the air inlet hole 24 at bottom of the trough 23 of the rear cover 20 will flow through the punching hole 34 and inlet switch groove 42, then enter into the first elongated punching channel 35 (indicated by arrow in the figure) through the sectional inlet adjusting holes 71, thus forming an air inlet mode with smaller rotational speed; similarly, when the inlet switch groove 42 is aligned simultaneously with two sectional inlet adjusting holes 71, 72, an air inlet mode with bigger rotational speed could be realized.

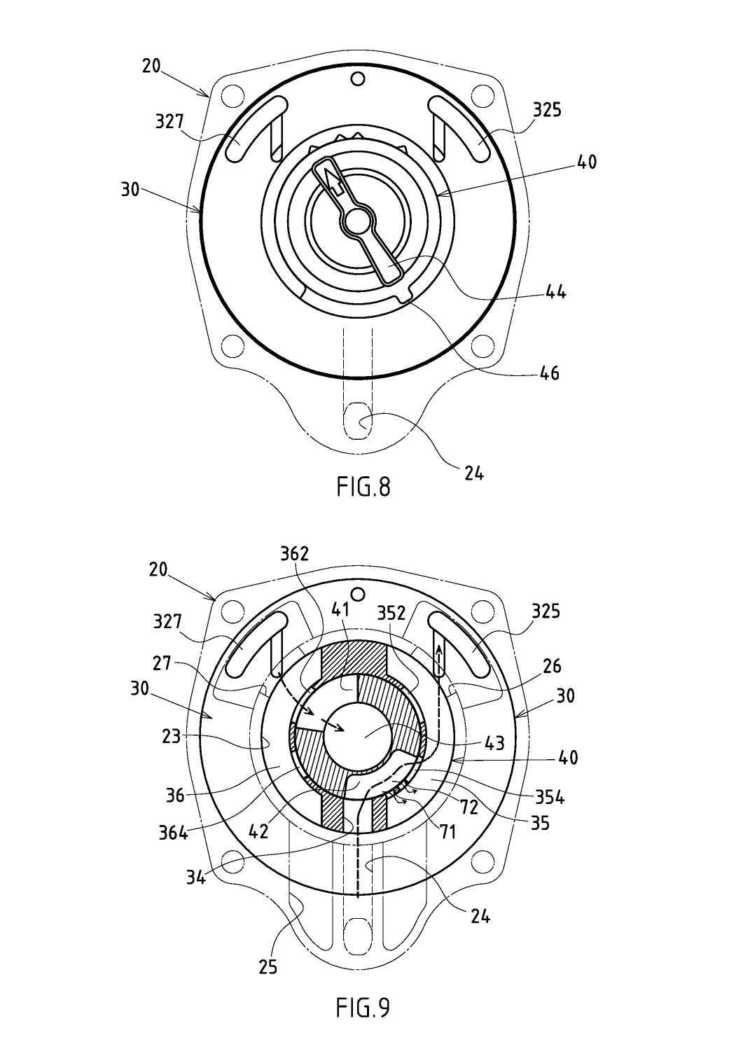

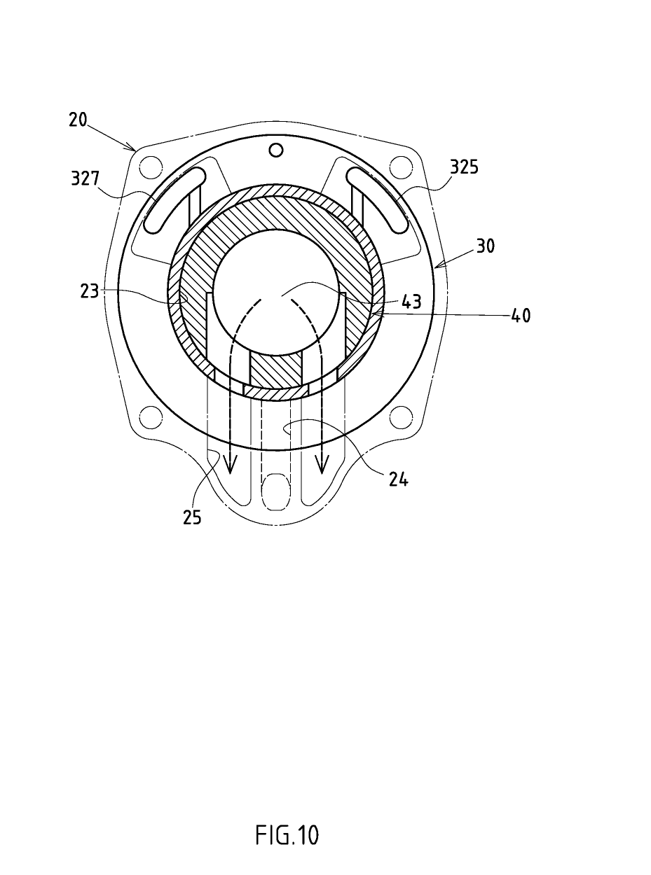

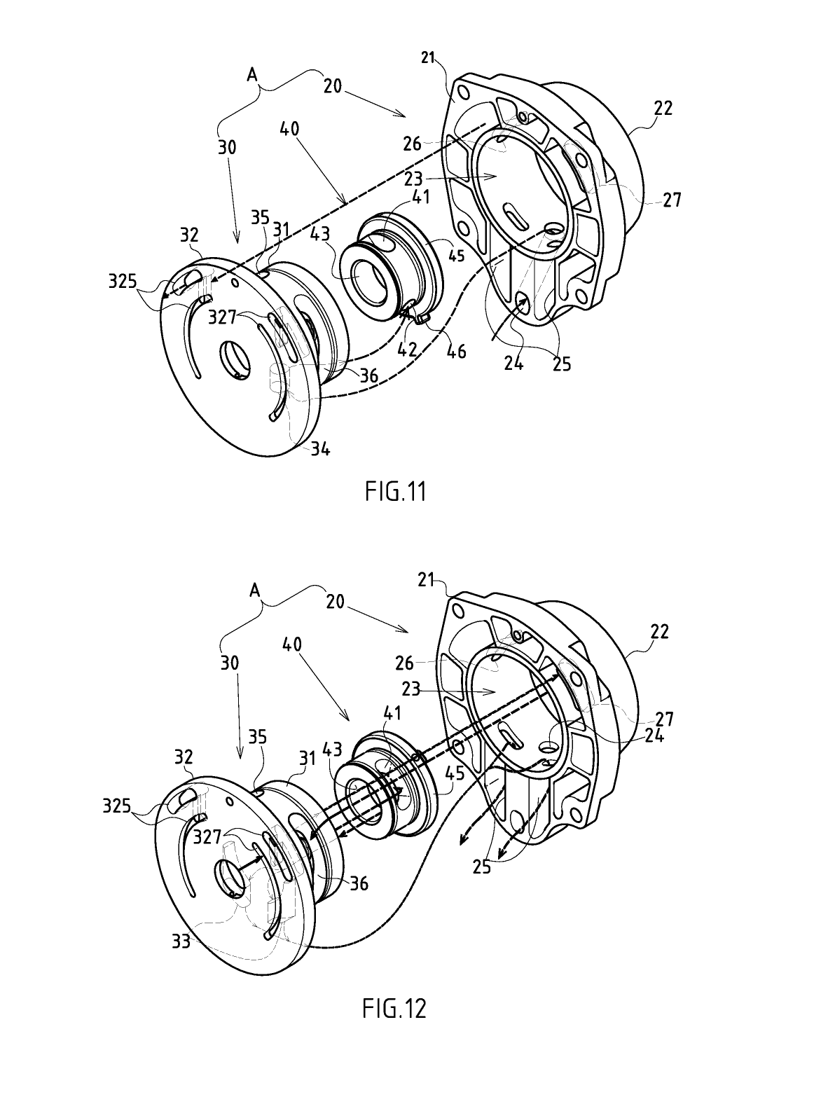

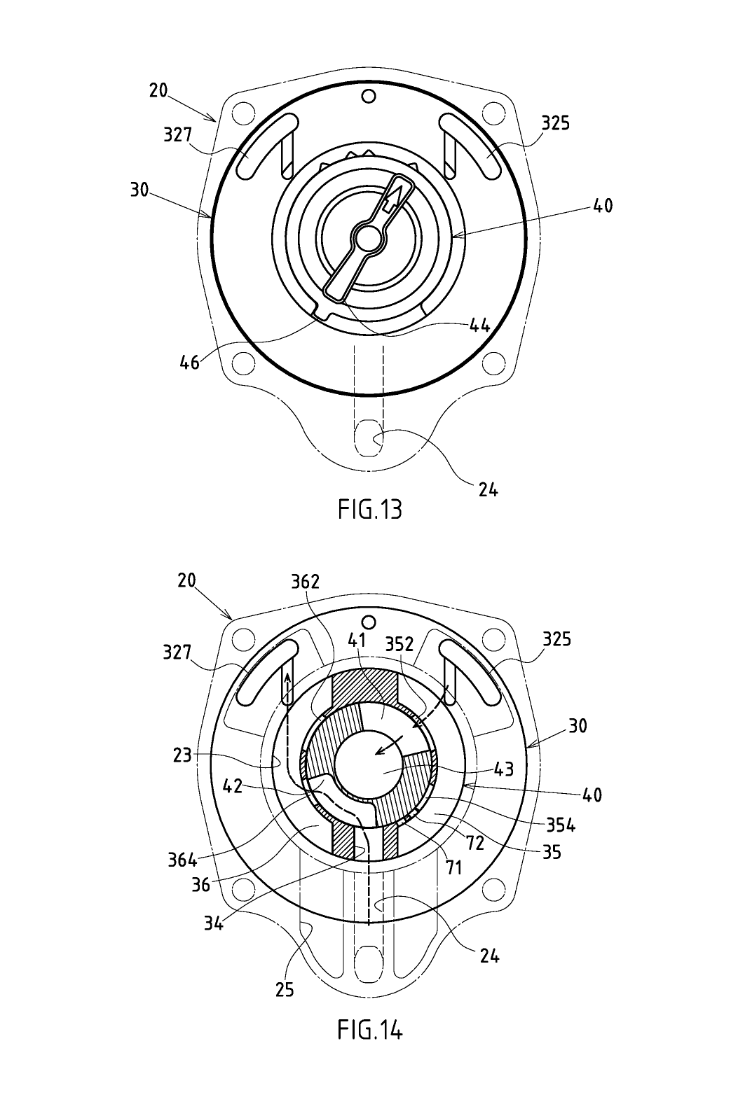

Based upon the above-specified technical characteristics, said reversing control mechanism A is operated as follows. The flow switching of said reversing control mechanism A of the present invention could be realized by the knob portion 44 formed at rear end of the flow switch control seat 40. When the knob portion 44 is rotated to a preset inlet closing mode, the inlet switch groove 42 of the flow switch control seat 40 is only aligned with the punching hole 34 of the diversion seat 30. Hence, air pressure guided from the air inlet hole 24 at bottom of the trough 23 of the rear cover 20 could only reach the inlet switch groove 42 through the punching hole 34, thus forming an air inlet closing state. Referring also to FIG. 8, the knob portion 44 is rotated to the first preset air inlet state, wherein the channel alignment state of the diversion seat 30 and flow switch control seat 40 is indicated by the thick broken arrow in FIGS. 9, 11. In such a case, the inlet switch groove 42 of the flow switch control seat 40 is aligned simultaneously with the punching hole 34 of the diversion seat 30 and the inlet hole 354 of the first elongated punching channel 35. Hence, air pressure guided from the air inlet hole 24 at bottom of the trough 23 of the rear cover 20 will flow through the punching hole 34, then is guided into the pneumatic portion 11 of the pneumatic tool 10 through the inlet switch groove 42 and inlet hole 354 of the first elongated punching channel 35, and then through the first exhaust channel 26 and first air diversion channel 325. The exhaust channel is indicated by the thick broken arrow in FIGS. 9, 10, 12, wherein air released from the pneumatic portion 11 of the pneumatic tool 10 (only marked in FIG. 1) is guided from the second air diversion channel 327 into the second exhaust channel 27, then into the exhaust hole 362 of the second elongated punching channel 36 at rear section 314 of the cylinder 31 of the diversion seat 30, and then through the exhaust switch groove 41 of the flow switch control seat 40 into the axial notch 43, next into the front end of the trough 23 of the rear cover 20 through the axial notch 43, and finally released from the exhaust hole 25 at bottom of the trough 23. When the knob portion 44 is rotated to the second preset air inlet mode as indicated by FIGS. 13, 14, the flow state hereto is represented by the left/right mirroring pattern of aforementioned first air inlet mode.

1. A reversing control mechanism of pneumatic tool, which is assembled correspondingly to the rear end of the pneumatic portion of the pneumatic tool, enabling to the switch the opening/closing of air pressure path and air inlet/exhaust mode of the pneumatic tool; said reversing control mechanism comprising:
a rear cover, comprising an assembly end and a rear side; said assembly end is assembled at the rear end of the pneumatic portion of the pneumatic tool; said rear cover is also provided with a trough, at bottom of which an air inlet hole and two exhaust holes are extended to the assembly end; a first exhaust channel and a second exhaust channel are arranged at left and right sides at top of the trough;
a reducing through-hole, set at the rear end of the trough of the rear cover for passing through the rear side of the rear cover;
a diversion seat, comprising a cylinder and an expanding disc set at front end of the cylinder; of which said cylinder is located into the trough of the rear cover, and the expanding disc is abutted onto the assembly end of the rear cover; said cylinder is divided into a front section and a rear section; the exhaust channels are set at bottom of the front section, and a punching hole is set at bottom of the rear section; the first and second elongated punching channels are separately arranged on the exterior side of the rear section of the cylinder; moreover, the exhaust holes are separately set at upper part of the first and second elongated punching channels, and separately linked to the inner upper part of the cylinder; inlet holes are separately set at lower part of the first and second elongated punching channels, and separately linked to the inner lower part of the cylinder; besides, the first and second air diversion channels are set symmetrically at two sides of the expanding disc;
a flow switch control seat, which is rotarily assembled into the rear section of the cylinder of the diversion seat; an exhaust switch groove and an inlet switch groove are separately set at upper and lower sides of the flow switch control seat; an axial notch recessed backwards is set at front end of the flow switch control seat; said axial notch is only connected with the exhaust switch groove, and separated from the inlet switch groove;
of which, a knob portion is formed at the rear end of the flow switch control seat, and located correspondingly to the reducing through-hole at the rear end of the trough on the rear cover, enabling the knob portion to be exposed.

2. The structure defined in claim 1, wherein an expanding limit groove is also set at the rear end of the cylinder of the diversion seat; a limiting notch is set at one side of the expanding limit groove; an expanding ring is set at rear end of the flow switch control seat, and can be accommodated into the expanding limit groove; moreover, a bulge set at one side of the expanding ring is located into the limiting notch, such that the maximum rotating angle of the flow switch control seat can be implemented as the displacement of the bulge is limited by the limiting notch.

3. The structure defined in claim 2, wherein an elastic bead is set on the expanding ring at the rear end of the flow switch control seat, while a plurality of locking flanges are spaced at one side of the expanding limit groove at the rear end of the cylinder of the diversion seat, such that the rotation state of the flow switch control seat could be located sectionally, allowing to identify the opening/closing of air pressure path and air inlet/exhaust mode of the pneumatic tool.

4. The structure defined in claim 3, wherein said knob portion formed at rear end of the flow switch control seat can be protruded out of the reducing through-hole, or located within the reducing through-hole.

5. The structure defined in claim 4, wherein a plurality of sectional inlet adjusting holes are arranged between the inlet hole at lower end of first elongated punching channel of the diversion seat and the punching hole of the diversion seat; the aperture of said sectional inlet adjusting holes is smaller than that of the inlet hole.
